(19) United States
(12) Patent Application Publication
(10) Pub. No.: US 2022/0193716 A1
(43) Pub. Date: Jun. 23, 2022

(54) DUAL BOND TIP CONTAINER AND METHOD

(71) Applicant: KISS NAIL PRODUCTS, INC., Port Washington, NY (US)

(72) Inventors: Jenny Jeong Eun Yang, Huntington Station, NY (US); Youlmae Lee, New York City, NY (US)

(21) Appl. No.: 17/499,660

(22) Filed: Oct. 12, 2021

Related U.S. Application Data
(63) Continuation-in-part of application No. 29/803,652, filed on Aug. 13, 2021.
(60) Provisional application No. 63/066,143, filed on Aug. 14, 2020.

(51) Int. Cl. B05C 17/005; B05C 11/10; B05C 1/06

(52) U.S. Cl. CPC B05C 17/00583; B05C 1/06; B05C 17/00553; B05C 11/10

(57) ABSTRACT

A container with multiple dispensing tips is described. One dispensing end is a high-precision tip. The opposing dispenser is a broad applicator. The end user squeezes the bottle, and depending on which tip is open, the contents are dispensed through the appropriate end.

The application claims priority as a non-provisional to U.S. provisional application 63/066,143, filed on Aug. 14, 2020, presently expired, and a continuation in part of U.S. design application 29/803,652, filed on Aug. 13, 2021, presently pending, the contents of which are incorporated by reference.

### BACKGROUND OF THE INVENTION

### 1. Field of the Invention

The field of the invention is a container with multiple egress points, with each egress point having a different configuration. One embodiment is used to store and dispense adhesive.

### 2. Background of the Invention

In various embodiments, the invention provides a device and method for dispensing of a product, such as a glue. Many products require applications over a large surface area, which is accomplished with a container that has a broad tip. At the same time, products also require an application to a precise area, which requires a dispensing tip that has a small aperture or opening.

In one embodiment, the invention comprises a reversibly deformable container having two tips. The first side has a precision tip, while the second side has a broad opening with a dispenser having a large surface area. In some embodiments, the main body of the container also has more than one compartment, such that a different product is dispensed from each side.

A need exists in the art for a container having the ability to dispense a product using a variety of tips.

### SUMMARY OF INVENTION

An object of the invention is to create a container that is suitable for dispensing solutions, such as adhesives, without contact with end-users fingers. A feature of the invention, in one embodiment, is that the container's main body is deformable and can be squeezed to begin dispensing the contents. An advantage of the invention is that it allows for controlled dispensing of a product without touching of same, a feature particularly advantageous when dispensing adhesive.

Another object of the invention is to allow the end-user to apply a precise amount of the product to a specific area. A feature of the invention is at least one dispensing tip in the product includes a small aperture and a dispensing lip. An advantage of the invention is that the end-user can direct the contents of the product to a specific area without touching the product.

A further object of the invention is to provide a container that can dispense its contents on a wide area. A feature of the invention is that the container includes a broad dispensing tip in one embodiment. This broad dispensing tip comprises a silicone tip. An advantage of one embodiment is that the end-user can spread the contents of the container over a wide area if desired.

A further object of the invention is to provide a dual-tip container. A feature of the invention is that in one embodiment, both a precision tip and a broad applicator are present on opposing sides of one container. An advantage of the container is that the end-user can select which side to use and apply the product as needed.

An additional object of the invention is to allow for dispensing of an adhesive, such as adhesives suitable for use with wigs that has a short drying time. A feature of the invention is that in one embodiment, the container allows for both fast broad applications and precision applications. An advantage of the system is that the end-user can apply multiple layers of the adhesive as needed in a short amount of time, selecting the correct tip as needed.

A further object of the invention is to allow for dispensing of an adhesive that has a waterproof component. A feature of the invention is that in one embodiment, the container has a separate compartment in fluid communication with a tip that houses the waterproof adhesive. An advantage of the system is that it allows for dispensing of a waterproof and non-waterproof version of an adhesive in a single container.

A benefit of the present invention is that it facilitates the application of glue to a beauty product with a large surface area, such as a wig. A large quantity of adhesive can be applied using one end of the container, while a small quantity of adhesive can be applied using the opposing end of the container. The dispenser is particularly adapted to add adhesive to a lace backing of a wig.

A dispensing container having multiple tips is described along with a method of use of the same. The container includes a precision tip and a broad applicator, per one embodiment of the invention.

### BRIEF DESCRIPTION OF DRAWINGS

The invention, together with the above and other objects and advantages, will be best understood from the following detailed description of the preferred embodiment of the invention shown in the accompanying drawings, wherein:

FIG. 1 depicts an overview of one embodiment of the invention;

FIG. 2 depicts another overview of one embodiment of the invention, showing the caps removed;

FIG. 3 depicts an overview of an embodiment of the caps of the invention;

FIG. 4 depicts an overview of another embodiment of the invention;

FIG. 5 depicts an overview of the embodiment of FIG. 4, but with the caps removed;

FIG. 6 depicts a flow chart of the method of use of one embodiment of the invention;

FIG. 7 depicts an example of use of an embodiment; and

FIGS. 8A and 8B depict another example of use of an embodiment.

### DETAILED DESCRIPTION OF THE INVENTION

The foregoing summary, as well as the following detailed description of certain embodiments of the present invention, will be better understood when read in conjunction with the appended drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

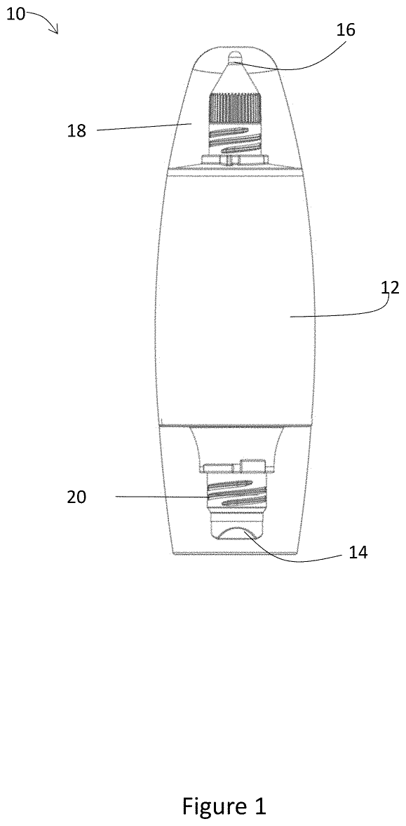

Turning to FIG. 1, shown therein is an embodiment 10 of the dual tip container. The dual tip container comprises a main body 12. In one embodiment, the main body 12 comprises a reversibly deformable plastic, such that an end-user can squeeze the main body and cause at least come contents of the main body 12 to exit one of the tips 14, 16.

The main body has two openings, each with a different tip 14, 16. A broad applicator tip 14 is found on the first end of the main body 12. The broad applicator tip 14 has a corresponding applicator cap 20. The second end of the main body 12 includes a precision tip 16, which also has a corresponding precision cap 18. Each cap 18, 20, is designed to prevent egress of the contents of the main body 12 through the corresponding tip 14, 16, even if pressure is applied to the main body 12.

In one embodiment, the interior compartment of the main body 12 comprises one internal chamber (not visible). In another embodiment, the main body 12 internal chamber includes a subdivision wall or bladder, such that one tip is in fluid communication with a first sub-chamber while the second tip is in fluid communication with a second sub-chamber. For example, in one embodiment, the precision tip 16 is used to dispense a waterproof adhesive, while the broad applicator tip 14 is used to dispense a water-soluble adhesive.

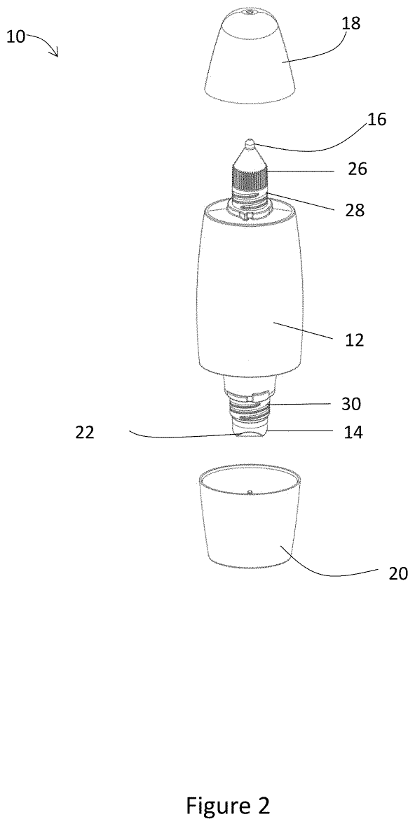

Turning to FIG. 2, depicted therein is the embodiment 10 with the caps 14, 18 removed.

As shown in FIG. 2, the precision tip 16 includes a cover 26, which helps guide the contents of the container 12 when exiting through the precision tip 16 upon application of pressure to the container 12. The cover 26 is permanently attached to the main body 12, in one embodiment. The cover 26 can include a variety of tips, in one embodiment. The cover 26 ensures that the precision tip 16 does not become untidy, especially when the container 12 is being used to dispense products that can dry and leave a residue, such as adhesives. The precision tip 16 includes an opening to allow for dispensing of a narrow line of the contents of the container 12 main body, as will be shown below.

The container main body also includes a threaded area 28 near the precision tip 16 and a corresponding threaded area 30 near the broad applicator 14. As shown in FIG. 2, the threaded areas 28 and 30 have different diameters, such that each cap will only fit in the assigned threaded area. For example, in the embodiment depicted in FIG. 2, the precision tip 16 threaded area 28 includes four layers, allowing for up to four twists of the cap. The broad applicator 20 threaded area 30 has only three layers of threads, and the threaded area has a diameter that is approximately 15% smaller. Therefore, neither cap will fit correctly on the opposite threaded area- to be securely attached to the container 12; each cap must be installed on the appropriate tip.

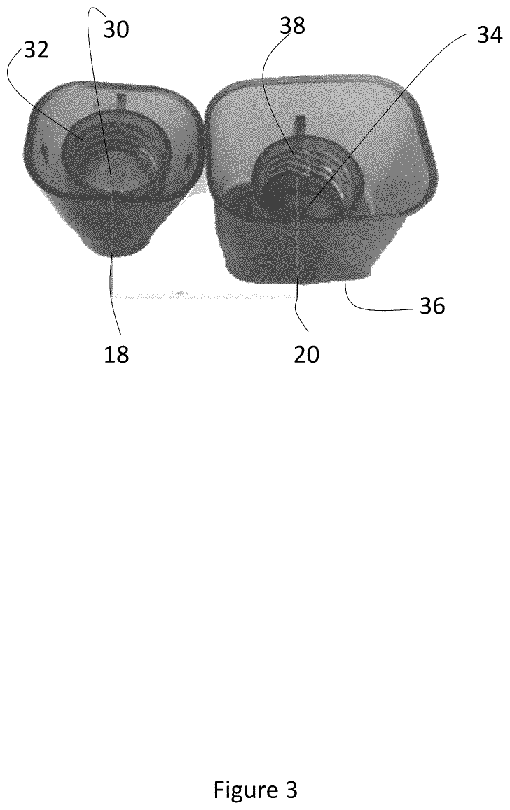

As shown in detail in FIG. 3, each cap has a corresponding receiving threaded interior.

The broad applicator 14, as shown in FIG. 2, does not include a cover; instead, it is directly received by the corresponding cap 20. The broad applicator 14 comprises a silicone tip 22, in one embodiment. A benefit of the silicone tip 22 is that it is non-reactive with both an end-user's skin and the product being dispensed by the embodiment 10. The silicone tip 22 includes at least one opening to dispense to the contents of the main body 12. In other embodiments, the tip 22 includes multiple small openings or a pattern on the applicator tip, such as a grate. In one embodiment, the applicator tip 22 includes a brush-like tip to allow for feathering of the contents after dispensing.

Turning to FIG. 3, depicted therein are the two caps 18 and 20. The precision tip cap 18 includes an interior area 30 designed to securely receive the cover of the precision tip, such as cover 26 shown in FIG. 2. In one embodiment, the interior area 30 includes a protrusion to help guide the tip to the central part of the interior area 30. The precision tip cap 18 also includes threads 32, which are designed to match the threads on the corresponding part of the container, as discussed above.

The broad applicator cap 20 likewise includes an interior area 34, which is designed to receive the broad applicator made from silicon shown in FIG. 2. The interior area 34 includes a flat area in one embodiment. In another embodiment, the interior area 34 includes an area with a variable surface to engage with the broad applicator. The interior area also includes threads 38 to removably attach to the broad applicator.

In one embodiment, the broad applicator cap 20 includes an external surface 36, which has a substantially flat profile. In this embodiment, the embodiment can stand on the broad applicator cap 20. For example, in FIG. 1, the embodiment 10 is shown standing upright on the cap 20.

In one embodiment, the caps 18 and 20 are made from a partially transparent material so that the end-user can verify that each cap has been correctly installed on the corresponding tip during use. In one embodiment, the caps include a high-gloss finish to create an attractive appearance and to distinguish the caps from a matte main body of the container.

In one embodiment, the caps 18, 20 are color-coded depending on the contents of the container. For example, one type of adhesive may include turquoise-colored caps, while a different type of adhesive may include gold-color caps. In another embodiment, the caps are opaque and not partially transparent.

The caps and threads are substantially airtight. The silicon tip is pliant to allow for broad application but has a sufficient degree of hardness to ensure that the dispensed adhesive is evenly spread when applied.

### Second Embodiment

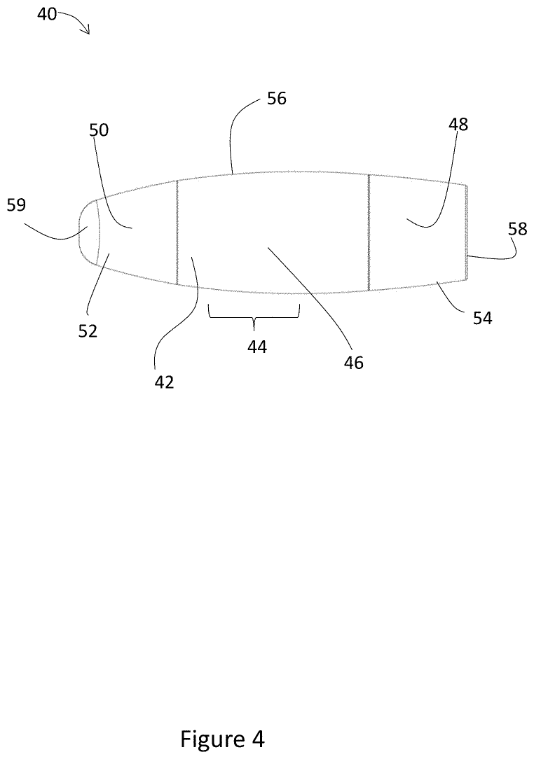

Another embodiment 40 of the invention is shown in FIG. 4. The embodiment main body 42 includes a central area 44. In the embodiment shown in FIG. 4, the central area 44 includes printed indicia 46. The printed indicia 46 includes identifying information, a logo, instructions, and combinations thereof, in one embodiment.

In the depicted embodiment, the broad applicator 48 and the precision tip 50 are behind their respective caps 52, 54. At least one side 56 of the main body 42 includes further printed indicia in an embodiment. The broad applicator 48 cap 52 has a flat area 58, to allow the main body 42 to rest on the flat area 58. The precision tip cap 52 terminates in a rounded area 59, instead.

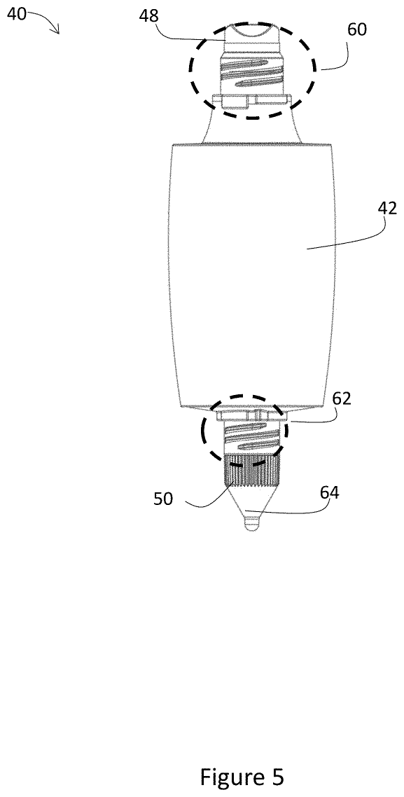

FIG. 5 depicts the second embodiment 40 of the main body 42 with the two caps removed. The broad dispenser applicator 48 includes its threaded area 60, while the precision tip 50 includes a corresponding threaded area 62. As explained above, in one embodiment, the two treaded areas 60, 62 are physically different to ensure that the correct cap is installed on the correct end. As explained above, the precision tip 50 is encapsulated by a cover 64. In one embodiment, the cover 64 is also threaded on the precision tip, but the threads are not shown. The threaded features of the tip and cover are different from the cap threads 62 shown in the figure. In another embodiment, the cover 64 is permanently attached.

In the embodiments shown in FIGS. 4 and 5, the high precision tip 50 is referred to as a ‘pen tip’ while the broad applicator 48 is referred to as the ‘broad tip.’

The main body 42 shown in FIG. 5 or the main body 12 shown in FIG. 1 comprises an opaque matte finish, in one embodiment. In another embodiment, the main body comprises a partially transparent material, so that the end-user can see how much of the product is left remaining. In another embodiment, the main body includes a transparent window on at least one side, allowing the end-user to see the quantity of the product remaining.

### Use Details

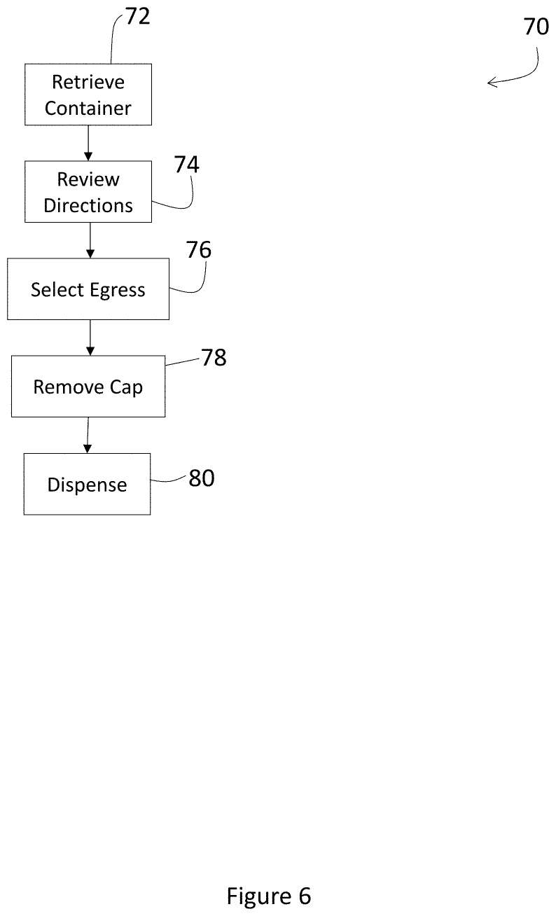

FIG. 6 depicts a flow chart showing the use of the product. The end-user will first retrieve the container 72. In some embodiments, the container is sold in a box to prevent accidental squeezing of the container. In another embodiment, the container is sold on the shelf with the caps attached using tamper-evident tape, which also prevents the product from exiting the container, even if it is squeezed. In another embodiment, the end-user must remove a film layer that hermetically seals the precision tip and the broad applicator of the container before first use.

Next, the end-user should review the directions 74 on the container in one embodiment. In another embodiment, the instructions are provided in detail on an accompanying disclosure.

The end-user then selects the egress 76, which the end-user will employ—either the precision tip or the broad applicator. Then, the end-user will remove the cap 78.

Finally, the end-user may dispense 80 the contents of the container 72. In one embodiment, the amount of product dispensed is a function of the amount of pressure applied to the main body of the container. The main body material is of sufficient hardness to require at least some pressure before the contents of the main body are dispensed.

A benefit of the invention is when the main body is squeezed, the caps and/or the cover remain in place and prevents residue from collecting in either cap.

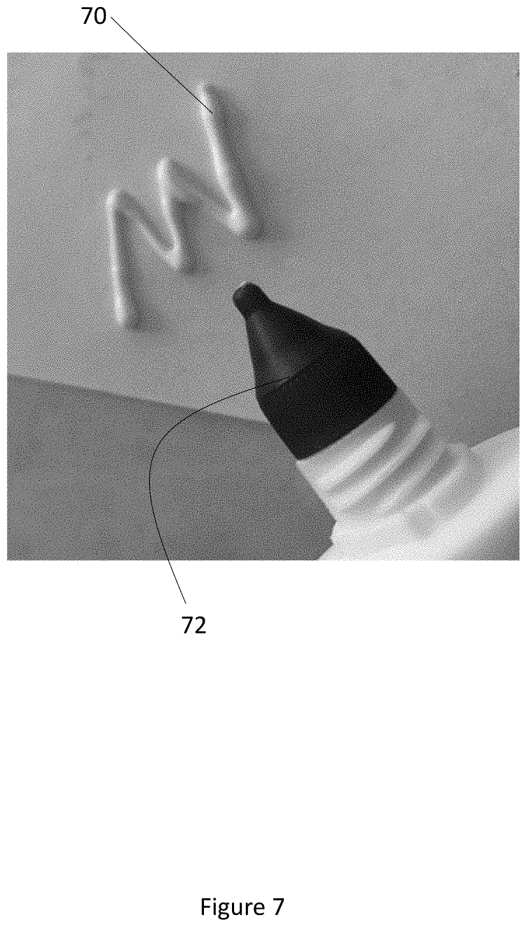

Example use of the precision tip is shown in FIG. 7. A narrow line 70 of the product is dispensed, while the tip cover 72 remains secure and does not twist off. There is no clogging of the tip 72, and the product exits the tip 72 seamlessly with a limited amount of pressure.

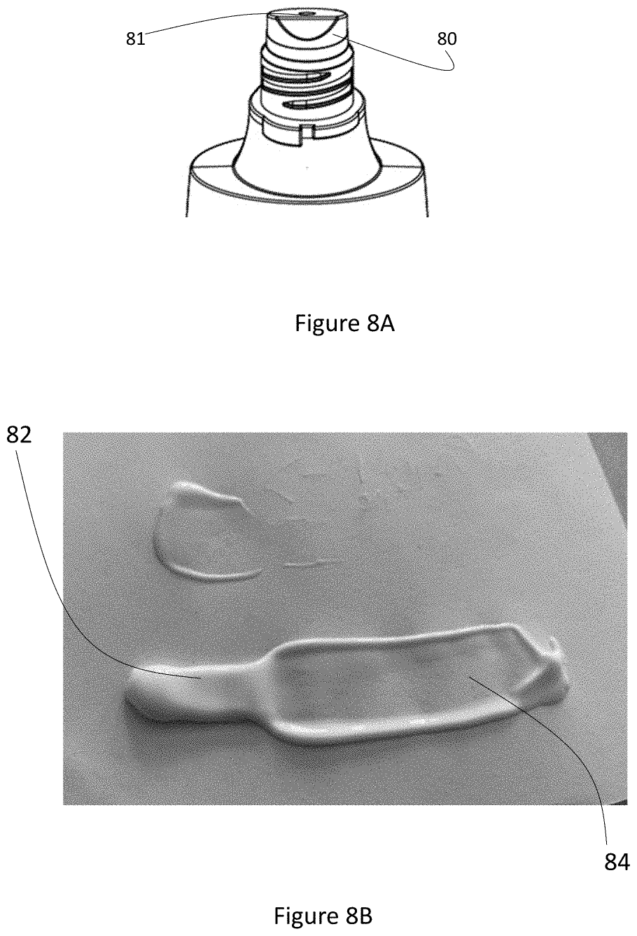

FIGS. 8A and 8B depict the use of the broad applicator 80. A wide stripe of the product 82 is created, and a flat area 84 can be created by pressing down on the stripe as the product is dispensed. The silicone tip 80 includes at least one opening 81. During use, the silicone tip is secure and does not twist off. The opening 81 does not clog. The adhesive or glue exits the applicator seamlessly with limited pressure. The adhesive is spread quickly with the side of the silicon applicator 80.

It is to be understood that the above description is intended to be illustrative and not restrictive. For example, the above-described embodiments (or aspects thereof) may be used in combination with each other. Also, many modifications may be made to adapt a particular situation or material to the teachings of the invention without departing from its scope. While the dimensions and types of materials described herein are intended to define the parameters of the invention, they are by no means limiting but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

1. A container comprising:
a main body containing a product having a first end and a second end;
a precision tip located at the first end;
a broad applicator located at the second end;
a first cap for the precision tip; and
a second cap for the broad applicator;
wherein pressure applied to the main body results in the product being dispensed from either the precision tip or the broad applicator, depending on which cap is removed.

2. The container of claim 1 wherein said product comprises an adhesive.

3. The container of claim 1 wherein said main body further comprises at least two sub-chambers, each sub-chamber in communication with a corresponding end.

4. The container of claim 1 wherein said broad applicator comprises a silicone tip.

5. The container of claim 1 wherein said precision tip comprises a cover which directs the flow of the product.

6. The container of claim 1 wherein said main body further comprises an area for printed indicia.

7. The container of claim 1 wherein each cap can be received by only one of the two ends.

8. The container of claim 1 wherein said second cap includes a surface having a substantially flat profile to allow for the container to stand on said substantially flat surface.

9. The container of claim 1 wherein each cap includes a thread with a specific diameter and the thread diameter of the first cap is different form the thread diameter of the second cap.

10. The container of claim 3 wherein one sub-chamber includes a water-soluble adhesive and the second sub-chamber includes a waterproof adhesive.

11. The container of claim 1 wherein each cap is partially transparent.

12. The container of claim 1 wherein each cap is color coded for the type of product contained in the main body of the container.
